(19) United States
(12) Patent Application Publication
(10) Pub. No.: US 2026/0279644 A1
(43) Pub. Date: Sep. 17, 2026

(54) MAGNETIC CORE AND COIL COMPONENT

(71) Applicant: TDK CORPORATION, Tokyo (JP)

(72) Inventors: Nobuhiro OKUDA, Tokyo (JP); Hiroyuki MATSUMOTO, Tokyo (JP); Kazuhiro YOSHIDOME, Tokyo (JP)

(73) Assignee: TDK CORPORATION, Tokyo (JP)

(21) Appl. No.: 19/679,921

(22) Filed: May 18, 2026

Related U.S. Application Data
(63) Continuation of application No. 17/082,389, filed on Oct. 28, 2020, now abandoned.

(30) Foreign Application Priority Data
Oct. 31, 2019 (JP) 2019-199177
Aug. 31, 2020 (JP) 2020-145893

(51) Int. Cl. H01F 27/255; H01F 1/153

(52) U.S. Cl. CPC H01F 27/255; H01F 1/153; Y10T 428/32

(57) ABSTRACT

A magnetic core having a high relative permeability is obtained.

The magnetic core contains soft magnetic metal powder particles. In a cross section of the magnetic core, a number ratio of soft magnetic metal powder particles having a circularity of less than 0.50 to a total number of soft magnetic metal powder particles having a particle size of 10 μm or more and less than 50 μm is 0.05% or more and 1.50% or less.

### BACKGROUND OF THE INVENTION

The present invention relates to a magnetic core and a coil component.

Patent Document 1 describes an invention relating to a soft magnetic alloy. It is described that a circularity of a particle cross section of a soft magnetic alloy powder is 0.5 or more. It is described that a powder packing density of a magnetic component manufactured using the soft magnetic alloy powder can be improved by increasing the circularity.
[Patent Document 1] JP Patent Application Laid Open No. 2018-73947

### BRIEF SUMMARY OF INVENTION

An object of the present invention is to obtain a magnetic core having a high relative permeability.

In order to attain the above object, a magnetic core according to the present invention is a magnetic core including soft magnetic metal powder particles,
wherein a number ratio of soft magnetic metal powder particles having a circularity of less than 0.50 to a total number of soft magnetic metal powder particles having a particle size of 10 μm or more and less than 50 μm is 0.05% or more and 1.50% or less in a cross section of the magnetic core.

By having the above characteristics, the magnetic core according to the present invention is a magnetic core having a high relative permeability.

The soft magnetic metal powder particles may be amorphous.

The soft magnetic metal powder particles may contain nanocrystals.

A coil component according to the present invention includes the magnetic core described above.

### BRIEF DESCRIPTION OF DRAWINGS

FIG. 1 is an example of a chart obtained by X-ray crystal structure analysis;

FIG. 2 is an example of a pattern obtained by profile fitting the chart in FIG. 1;

FIG. 3 is a schematic view of a metal powder manufacturing device; and

FIG. 4 is a graph showing a relationship between a number ratio of particles having a low circularity and a relative permeability.

### DETAILED DESCRIPTION OF INVENTION

An embodiment of the present invention will be described below with reference to the drawings.

A magnetic core according to the present embodiment is a magnetic core containing soft magnetic metal powder particles,
wherein a number ratio of soft magnetic metal powder particles having a circularity of less than 0.50 to a total number of soft magnetic metal powder particles having a particle size of 10 μm or more and less than 50 μm is 0.05% or more and 1.50% or less in a cross section of the magnetic core.

The number ratio of the soft magnetic metal powder particles having the circularity of less than 0.50 to the total number of the soft magnetic metal powder particles having the particle size of 10 μm or more and less than 50 μm may be 0.07% or more and 1.40% or less.

In general, the magnetic core including the soft magnetic metal powder particles (hereinafter, may be simply referred to as particles) tends to have a high permeability as the particles are filled at high density. In order to fill the particles at high density, it is preferable that the circularity of the particles is high.

It is known that, as the particles are filled at high density and a large number of particles are in contact with each other, an effective demagnetizing field coefficient between the particles decreases and the magnetic core containing the particles tends to have the high permeability.

When a magnetic field is applied to the particle, a positive magnetic pole is generated at one end of the particle, and a negative magnetic pole is generated at the other end thereof. The magnetic field generated inside the particle by the positive magnetic pole and the negative magnetic pole is a demagnetizing field. A strength of the demagnetizing field is proportional to a demagnetizing field coefficient. The demagnetizing field coefficient is determined by a shape (the circularity) of the particle when the particle is isolated from other particles. However, when the particles are in contact with each other, the magnetic poles thereof cancel each other out.

Therefore, the demagnetizing field coefficient is a relatively small value called the effective demagnetizing field coefficient.

The following Ollendorf equation is known as an equation expressing a relative permeability of the magnetic core. μ is the relative permeability of the magnetic core, η is a packing density of the particles, μ₀ is a vacuum permeability, μₘ is a permeability of the particles, and N is the effective demagnetizing field coefficient.

$$μ = \frac{η ( {μ}_{m} - {μ}_{0} )}{N ( 1 - η ) ( {μ}_{m} - {μ}_{0} ) + {μ}_{0}} + 1$$

When particles having a low circularity, specifically, particles having a circularity of less than 0.50 are included in the magnetic core within the above range of the number ratio of the particles having the low circularity, it has been found that the relative permeability can be further improved as compared with a case where the particles having the low circularity are included in the magnetic core out of the above range of the number ratio of the particles having the low circularity.

When the number ratio of the particles having the low circularity is too small, the relative permeability is lower than that in a case where the number ratio of the particles having the low circularity at the same packing density is within the above range.

When the number ratio of the particles having the low circularity is too large, powder compaction at a higher pressure is required in order to increase the packing density of the magnetic core. As the pressure during the powder compaction becomes high, a load on a manufacturing device becomes large and a cost becomes high. Even if the packing density can be increased, the relative permeability is lower than that in the case where the number ratio of the particles having the low circularity is within the above range at the same packing density. This is because when the powder compaction is performed at the high pressure, the permeability (the above μm) of the particles decreases due to an inverse magnetostrictive effect.

Hereinafter, a definition of the circularity, a method of measuring the number ratio of the particles having the circularity of less than 0.50, and a method of calculating the packing density will be described.

In the present embodiment, the circularity is 2×(π×cross-sectional area)^{1/2}/(perimeter of cross section). A circularity of a perfect circle is 1, and the circularity decreases as a shape becomes distorted.

In order to measure the number ratio of the particles having the circularity of less than 0.50 to the total number of the particles having the particle size of 10 μm or more and less than 50 μm, first, the magnetic core is cut parallel to a molding direction and a cross section obtained is polished to prepare an observation surface. Next, the observation surface is observed by an SEM, and an SEM image is captured. The particle size is a circle equivalent diameter. Specifically, a diameter of a perfect circle corresponding to a cross-sectional area of the particle on the observation surface is the circle equivalent diameter.

A size of an observation range by the SEM is not particularly limited, and 2000 or more, preferably 20000 or more particles having the particle size of 10 μm or more and less than 50 μm may be observed. Different observation ranges may be set on one observation surface, an SEM image of each observation range may be captured, and the above number of particles may be observed in a total of a plurality of SEM images.

A magnification of the SEM image is not particularly limited, and the circularity of the particles having the particle size of 10 μm or more and less than 50 μm may be measured. For example, the magnification may be 200 times or more and 1000 times or less.

The number ratio of the particles having the particle size of 10 μm or more and less than 50 μm to the particles contained in the magnetic core according to the present embodiment is not particularly limited. For example, the number ratio is 20% or more. When the number ratio is calculated, fine particles having a particle size of less than 1 μm are ignored.

The circularity is obtained as follows. First, the SEM image is binarized by image processing software to obtain a monochrome image. Next, the obtained monochrome image is processed by image analysis software to measure a cross-sectional area, a perimeter, and a circle equivalent diameter of each particle. For particles having a circle equivalent diameter of 10 μm or more and less than 50 μm, the circularity is calculated from the above equation. Then, the number ratio of the particles having the circularity of less than 0.50 is calculated. Hereinafter, the particles having the particle size of 10 μm or more and less than 50 μm and having the circularity of less than 0.50 may be referred to as the particles having the low circularity.

The method of calculating the packing density of the magnetic core is not particularly limited. For example, the calculation can be performed by the following method. The magnetic core is cut parallel to the molding direction and the cross section obtained is polished to prepare the observation surface. Next, the observation surface is observed using the SEM. An area ratio of the particles to a total area of the observation surface is calculated. In the present embodiment, the area ratio is regarded as equal to the packing density, and the area ratio is defined as the packing density. When the packing density is calculated, the observation surface has a size including 2000 or more particles, preferably 20000 or more particles.

The packing density may be calculated by calculating an density (an ideal density) when the packing density is assumed to be 100% from a true density and a blending ratio of a soft magnetic metal powder as a raw material, and dividing the measured density actually calculated from a dimension and a weight of the magnetic core by the ideal density. The packing density calculated from the SEM is substantially equal to the packing density calculated from the measured density and the ideal density.

A microstructure of the particles is not particularly limited. For example, the particles may have an amorphous structure or may have a crystal structure. A structure formed of nanocrystals having an average crystal grain size of 0.1 nm or more and 100 nm or less may be contained. In a particle containing crystals, particularly nanocrystals, a large number of crystals are usually contained in one particle. That is, particle sizes and crystal grain sizes of the particles are different. A method of calculating the crystal grain size is not particularly limited. For example, the crystal grain size can be calculated by observation using a TEM.

Further, the nanocrystals contained in the particles may be Fe-based nanocrystals. The Fe-based nanocrystals are crystals having an average crystal grain size on a nano-order (specifically, 0.1 nm or more and 100 nm or less) and a Fe crystal structure that is a bcc (body-centered cubic lattice structure). A method of calculating the average crystal grain size of the Fe-based nanocrystals is not particularly limited. For example, the average crystal grain size can be calculated by observation using the TEM. There is no particular limitation on a method of confirming that the crystal structure is the bcc. For example, the crystal structure can be confirmed by using an XRD.

In the present embodiment, the Fe-based nanocrystals may have an average crystal grain size of 5 to 30 nm. Particles having a structure formed of such Fe-based nanocrystals tend to have high Bs and low Hcj. That is, soft magnetic properties are easily improved. Further, soft magnetic properties of the magnetic core containing the particles are easily improved.

A composition of the particles is not particularly limited. For example, Fe may be contained, and Fe and B may be contained. When the particles contain Fe and B, the microstructure of the particles can be easily controlled. The particles may further comprise Si. When the particles contain Si, the soft magnetic properties of the particles are easily improved, and the soft magnetic properties of the magnetic core containing the particles are easily improved. Specifically, the particles tend to have low Hcj and high Bs, and the soft magnetic properties of the magnetic core containing the particles are easily improved.

When the particles have the structure formed of the Fe-based nanocrystals, the particles may have a main component formed of, for example, a composition formula (Fe_{(1-(α+β))}X1_{α}X2_{β})_{(1-(a+b+c+d+e+f))}MₐB_{b}P_{c}Si_{d}CₑS_{f}, in which
X1 is one or more selected from the group consisting of Co and Ni,
X2 is one or more selected from the group consisting of Al, Mn, Ag, Zn, Sn, As, Sb, Cu, Cr, Bi, N, O and rare earth elements,
M is one or more selected from the group consisting of Nb, Hf, Zr, Ta, Mo, W, Ti and V, and the following conditions may be satisfied:

$$0. \leq a \leq 0.1 \; 40$$

$$0. \leq b \leq 0.20$$

$$0. \leq c \leq 0.20$$

$$0 \leq d \leq 0.14$$

$$0 \leq e \leq 0.2$$

$$0 \leq f \leq 0.02$$

$$0.698 \leq 1 - ( a + b + c + d + e + f ) \leq 0. 93$$

$$α \geq 0$$

$$β \geq 0$$

$$0 \leq α + β \leq 0.50$$

The above composition formula is expressed by an atomic number ratio.

0.01≤b≤0.20 may be satisfied. By containing B, the particles tend to have a structure formed of the Fe-based nanocrystals.

In a method of manufacturing the magnetic core to be described later, when a soft magnetic metal powder containing particles having the above composition is heat-treated, the Fe base nanocrystals are easily precipitated in the particles. In other words, the soft magnetic metal powder having the above composition can be easily used as a starting material for the soft magnetic metal powder having the particles in which the Fe-based nanocrystals are precipitated.

When the Fe base nanocrystals are precipitated in the particles by the heat treatment, the particles before the heat treatment may have a structure formed of only an amorphous substance, and may have a nanoheterostructure in which initial crystallites are present in the amorphous substance. The initial crystallites may have an average particle size of 0.3 nm or more and 10 nm or less. When the particles have the structure formed of only the amorphous substance, or the nanoheterostructure, an amorphization rate X to be described later is 85% or more.

The method of manufacturing the magnetic core according to the present embodiment will be described below, but the method of manufacturing the magnetic core is not limited to the following method.

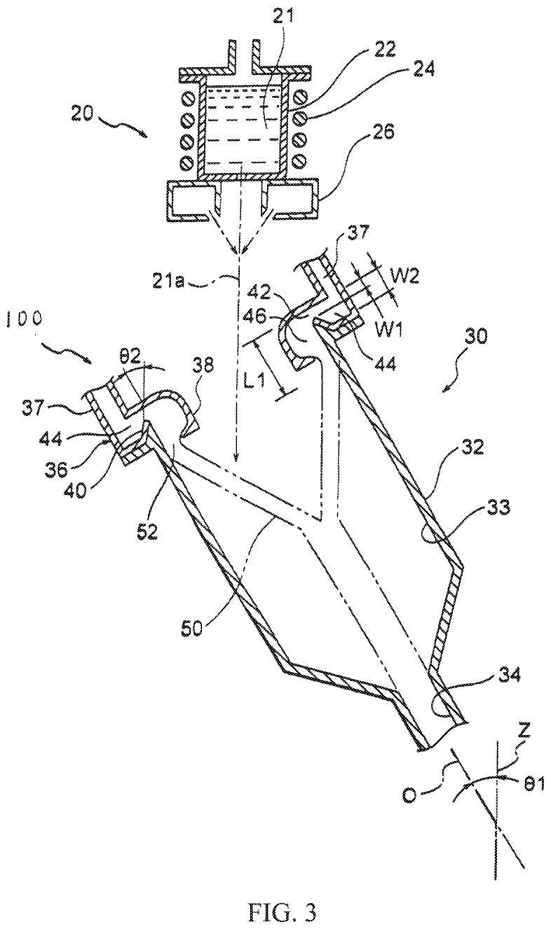

First, the soft magnetic metal powder containing the particles according to the present embodiment is prepared. The soft magnetic metal powder containing the particles according to the present embodiment can be prepared, for example, by a gas atomizing method. In particular, the soft magnetic metal powder is prepared by the gas atomizing method using a metal powder manufacturing device 100 shown in FIG. 3, whereby the obtained soft magnetic metal powder has the particles according to the present embodiment.

The metal powder manufacturing device 100 shown in FIG. 3 is a device for powdering a molten metal 21 by the gas atomizing method to obtain the particles according to the present embodiment. The metal powder manufacturing device 100 includes a molten metal supply unit 20 and a cooling unit 30 disposed below the molten metal supply unit 20 in a vertical direction. The vertical direction in FIG. 3 is a direction along a Z axis.

The molten metal supply unit 20 includes a heat-resistant container 22 that accommodates the molten metal 21. A heating coil 24 is disposed on an outer periphery of the heat-resistant container 22 to heat the molten metal 21 accommodated in the container 22 and maintain the molten metal 21 in a molten state. A discharge port is formed at a bottom portion of the container 22, from which the molten metal 21 is discharged as a dropped molten metal 21a toward an inner surface 33 of a cylindrical body 32 constituting the cooling unit 30.

A gas injection nozzle 26 is disposed on an outer portion of an outer bottom wall of the container 22 so as to surround the discharge port. The gas injection nozzle 26 is provided with a gas injection port. A high-pressure gas (a gas having an injection pressure (a gas pressure) of 2 MPa or more and 12 MPa or less) is injected from the gas injection port toward the dropped molten metal 21a discharged from the discharge port. The high-pressure gas is injected obliquely downward from the entire circumference of the molten metal discharged from the discharge port, and the dropped molten metal 21a becomes a large number of droplets and is conveyed toward the inner surface of the cylindrical body 32 along a flow of the gas.

When the gas pressure of the high-pressure gas is 2 MPa or more and 12 MPa or less, the number ratio of the particles having the circularity of less than 0.50 is likely to increase to 0.05% or more. On the other hand, when a related-art metal powder manufacturing device is used or when the gas pressure is too low, the number ratio of the particles having the circularity of less than 0.50 is less likely to be 0.05% or more. When the gas pressure is too high, the number ratio of the particles having the circularity of less than 0.50 is less likely to be 1.50% or less.

A composition of the molten metal 21 is the same as the composition of the finally obtained particles. As described above, the metal powder manufacturing device 100 can easily powder even the easily oxidizable molten metal 21 by using an inert gas as the gas to be injected from the gas injection port of the gas injection nozzle 26.

The gas injected from the gas injection port is preferably the inert gas such as a nitrogen gas, an argon gas or a helium gas, or a reducing gas such as an ammonia decomposition gas. Air may be used depending on ease of oxidation of the molten metal 21.

In the present embodiment, an axial center O of the cylindrical body 32 is inclined at a predetermined angle θ1 with respect to the vertical line Z. The predetermined angle θ1 is not particularly limited, but is preferably 0 to 45 degrees. With such an angle range, the dropped molten metal 21a from the discharge port can be easily discharged toward the coolant flow 50 formed in an inverted conical shape inside the cylindrical body 32.

The dropped molten metal 21a discharged into the inverted conical coolant flow 50 collides with the coolant flow 50, is further divided into fine particles, and is cooled and solidified to become a solid soft magnetic metal powder. A discharge portion 34 is provided below along the axial center O of the cylindrical body 32 so that the soft magnetic metal powder contained in the coolant flow 50 can be discharged to outside together with a coolant. The soft magnetic metal powder discharged together with the coolant is separated from the coolant in an external storage tank or the like and taken out. The coolant is not particularly limited, but a cooling water is used.

In the present embodiment, a coolant introduction portion (a coolant lead-out portion) 36 that introduces the coolant into the cylindrical body 32 is provided at an upper portion of the cylindrical body 32 in an axial center O direction. From a viewpoint of discharging the coolant from the upper portion of the cylindrical body 32 toward inside of the cylindrical body 32, the coolant introduction portion 36 can also be defined as the coolant lead-out portion.

The coolant introduction portion 36 includes at least a frame body 38, and includes therein an outer portion (an outer space portion) 44 located radially outward in the cylindrical body 32 and an inner portion (an inner space portion) 46 located radially inward in the tubular body 32. The outer portion 44 and the inner portion 46 are partitioned by a partition portion 40, and the outer portion 44 and the inner portion 46 communicate with each other by a passage portion 42 formed in an upper portion of the partition portion 40 in the axial center O direction, so that the coolant can flow. As shown in FIG. 3, in the outer portion 44, the partition portion 40 is inclined at an angle θ2 with respect to the axial center O. The angle θ2 is preferably in a range of 0 to 90 degrees, more preferably 0 to 45 degrees. In the inner portion 46, a wall surface of the partition portion 40 is preferably flush with the inner surface 33 of the cylindrical body 32, but is not necessarily flush with the inner surface 33 of the cylindrical body 32, and may be slightly inclined or have a step.

A single or a plurality of nozzles 37 are connected to the outer portion 44 so that the coolant enters the outer portion 44 from the nozzles 37. A coolant discharge portion 52 is formed below the inner portion 46 in the axial center O direction, from which the coolant in the inner portion 46 is discharged (led out) into the cylindrical body 32.

In the present embodiment, the frame body 38 of the coolant introduction portion 36 is disposed at the upper portion of the cylindrical body 32 in the axial center O direction, and has a cylindrical shape whose an outer diameter is smaller than an inner diameter of the cylindrical body 32. An outer circumferential surface of the frame body 38 serves as an inner circumferential surface of a flow path that guides a flow of the coolant in the inner portion 46.

The outer portion 44 and the inner portion 46 communicate with each other by the passage portion 42 provided at the upper portion of the partition portion 40 in the axial center O direction. The passage portion 42 is a gap between an upper plate of the coolant introduction portion 36 and an upper end of the partition portion 40, and a vertical width W1 of the passage portion 42 in the axial center O direction (see FIG. 3) is smaller than a vertical width W2 of the outer portion 44 in the axial center O direction. W1/W2 is preferably ¼ or more and ⅓ or less. With such a range, the inverted conical flow 50 is easily formed by reflection of the coolant on the inner surface 33 of the cylindrical body 32 to be described later.

In the present embodiment, the nozzle 37 is connected to the outer portion 44 of the coolant introduction portion 36. By connecting the nozzle to the outer portion 44 of the coolant introduction portion 36, the coolant enters inside of the outer portion 44 which is inside the coolant introduction portion 36 from the nozzle 37. The coolant that has entered the inside of the outer portion 44 passes through the passage portion 42 and enters inside of the inner portion 46.

The frame body 38 has an inner diameter smaller than that of the inner surface 33 of the cylindrical body 32.

In the present embodiment, the coolant discharge portion 52 is formed in a gap between an outward protrusion of a lower end of the frame body 38 and the inner surface 33 of the cylindrical body 32. A radial width of the coolant discharge portion is larger than a vertical width W1 of the passage portion.

An inner diameter of the coolant discharge portion 52 coincides with a maximum outer diameter of a flow path deflection surface, and an outer diameter of the coolant discharge portion 52 substantially coincides with the inner diameter of the cylindrical body 32. The outer diameter of the coolant discharge portion 52 may also coincide with the inner surface 33 of the cylindrical body 32. The inner diameter of the inner surface 33 of the cylindrical body 32 is not particularly limited, but is preferably 50 to 500 mm.

In the present embodiment, the coolant, which is temporarily stored in the outer portion 44 from the nozzle 37, passes through the passage portion 42 therefrom, and enters the inside of the inner portion 46, flows downward along the axial center O along the inner circumferential surface of the flow path of the frame body 38. The coolant flowing downward along the axial center O along the inner circumferential surface of the flow path inside the inner portion 46 then flows along the flow path deflection surface of the frame body 38 and collides with the inner surface 33 of the cylindrical body 32 to be reflected. As a result, the coolant is discharged from the coolant discharge portion 52 into the cylindrical body 32 in the inverted conical shape to form the coolant flow 50 as shown in FIG. 3.

The coolant flow 50 flowing out from the coolant discharge portion 52 is an inverted conical flow traveling straight from the coolant discharge portion 52 toward the axial center O, but may be a spiral inverted conical flow.

As shown in FIG. 3, an axial length L1 of the frame body 38 may be long enough to cover the width W1 of the passage portion 42 in the axial center O direction.

In the present embodiment, the coolant that has entered the outer portion 44 from the nozzle 37 is temporarily stored in the outer portion 44, passes through the passage portion 42 therefrom, thereby entering the inner portion 46 at an increased flow velocity. In the inner portion 46, the coolant that has passed through the passage portion 42 collides with a curvature surface formed on the inner circumferential surface of the flow path of the frame body 38, and a direction of the flow of the coolant is changed downward along the axial center O.

The coolant flowing downward along the axial center O inside the inner portion 46 then increases in the flow velocity due to narrowing of a flow path cross section. Then, the coolant collides with the inner surface of the cylindrical body 32 to be reflected while the flow velocity is increased, and is discharged from the coolant discharge portion 52 into the cylindrical body 32 in the inverted conical shape to form the coolant flow 50 as shown in FIG. 3. Droplets of the dropped molten metal 21a shown in FIG. 3 are incident on an upper liquid surface of the inverted conical coolant flow 50 formed in this manner, and the droplets of the dropped molten metal 21a flow together with the coolant inside the coolant flow 50 to be cooled.

In a method of manufacturing the soft magnetic metal powder using the metal powder manufacturing device 100 according to the present embodiment, an inlet for the droplets of the dropped molten metal 21a is formed in an upper opening of the cylindrical body 32, and the inverted conical coolant flow 50 is formed in the upper opening of the cylindrical body 32. The inverted conical coolant flow 50 is formed in the upper opening of the cylindrical body 32, and the coolant is discharged from the discharge portion 34 of the cylindrical body 32, whereby a suction pressure into the cylindrical body 32 is obtained in the upper opening of the cylindrical body 32. For example, a suction pressure having a differential pressure of 30 kPa or more from the outside of the cylindrical body 32 can be obtained.

Therefore, the droplets of the dropped molten metal 21a is sucked into the cylindrical body 32 from the upper opening of the cylindrical body 32 in a self-aligning manner (automatically sucked even if the position is slightly displaced), and are taken into the inverted conical coolant flow 50. Therefore, a flight time of the droplets of the dropped molten metal 21a from the discharge port of the molten metal supply unit 20 to the coolant flow 50 is relatively shortened. As the flight time is shortened, the droplets of the dropped molten metal 21a is less likely to be oxidized. Then, a quenching effect is promoted, and a soft magnetic metal portion is likely to have the amorphous structure.

In the present embodiment, the droplets of the dropped molten metal 21a are taken into the inverted conical coolant flow instead of a coolant flow along the inner surface 33 of the cylindrical body 32. Therefore, inside the cylindrical body 32, a residence time of cooled particles 1 can be shortened, and damage to the inner surface 33 of the cylindrical body 32 is also small. In addition, there is little damage to the cooled particles themselves.

Further, in the present embodiment, no processing is required on the inner surface 33 of the cylindrical body 32 and nothing needs to be attached, and the inverted conical coolant flow 50 can be formed by simply attaching the coolant lead-out portion 36 to the upper portion of the cylindrical body 32. An inner diameter of the upper opening of the cylindrical body 32 can also be sufficiently large.

The soft magnetic metal powder obtained by using the metal powder manufacturing device 100 may be heat-treated. Heat treatment conditions are not particularly limited. For example, the heat treatment may be performed at 400° C. to 700° C. for 0.1 to 10 hours. By performing the heat treatment, when the microstructure of the particles is the structure formed of only the amorphous substance, or the nanoheterostructure in which the initial crystallites are present in the amorphous substance, the microstructure of the particles is likely to be a structure containing the nanocrystals. Then, Hcj of the soft magnetic metal powder tends to decrease. When a temperature of the heat treatment is too high, the Hcj of the soft magnetic metal powder tends to increase.

A method of confirming the microstructure of the soft magnetic metal powder is not particularly limited. For example, the microstructure can be confirmed by the XRD. The microstructure of the soft magnetic metal powder before the powder compaction and the microstructure of the particles contained in the magnetic core after the powder compaction are usually the same.

In the present embodiment, the soft magnetic metal portion contained in the soft magnetic metal powder having an amorphization rate X of 85% or more shown in the following equation (1) has an amorphous structure, and the soft magnetic metal portion contained in the soft magnetic metal powder having an amorphization rate X of less than 85% has a crystal structure.

$$X = 100 - ( Ic / ( Ic + Ia ) \times 100 ) \qquad ( 1 )$$

Ic: crystalline scattering integral intensity
Ia: amorphous scattering integral intensity

The amorphization rate X is calculated by the above equation (1) in which X-ray crystal structure analysis is performed on the soft magnetic metal powder by the XRD, a phase is identified, and a peak of crystallized Fe or a compound (Ic: crystalline scattering integral intensity, Ia: amorphous scattering integral intensity) is read, and a crystallization rate is calculated from the peak intensity. A calculation method will be described in more detail below.

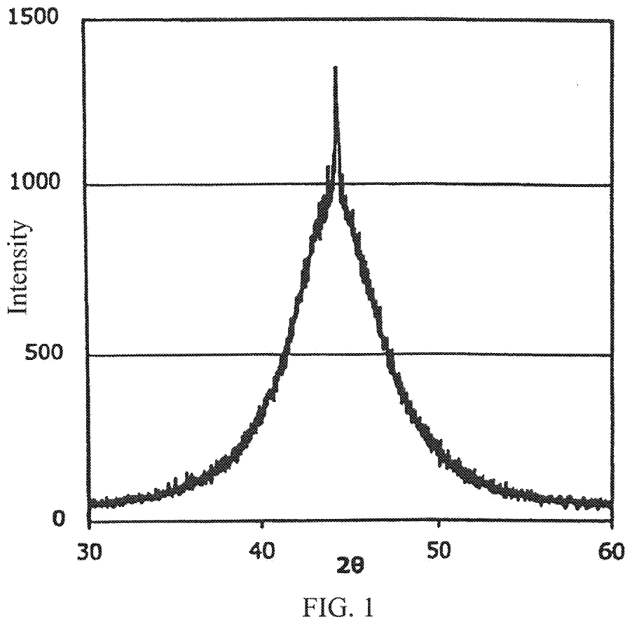

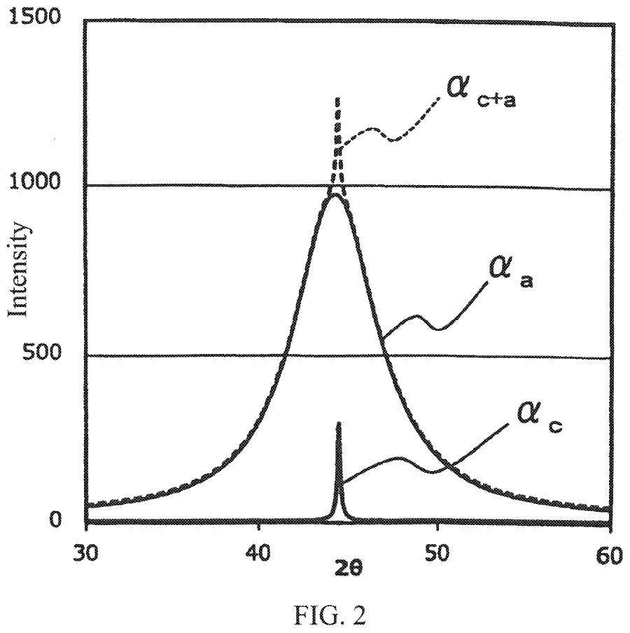

The X-ray crystal structure analysis is performed on the soft magnetic metal powder according to this embodiment by the XRD, and a chart as shown in FIG. 1 is obtained. This is profile-fitted using the Lorentzian function of the following equation (2) to obtain a crystal component pattern α_{c} showing the crystalline scattering integral intensity, an amorphous component pattern αₐ showing the amorphous scattering integral intensity, and a pattern α_{c+a} obtained by combining these as shown in FIG. 2. From the crystalline scattering integral intensity and the amorphous scattering integral intensity of the obtained pattern, the amorphization rate X is obtained by the above equation (1). A measurement range is a diffraction angle of 2θ=30° to 60° at which an amorphous-derived halo can be confirmed. In this range, an error between an integral intensity measured by the XRD and an integral intensity calculated using the Lorentzian function was within 1%.

$$f ( x ) = \frac{h}{1 + \frac{{( x - u )}^{2}}{{w}^{2}}} + b \qquad ( 2 )$$

h: peak height
u: peak position
w: half-value width
b: background height

The method of manufacturing the magnetic core when the magnetic core is a dust core will be described below. The method of manufacturing the magnetic core is not particularly limited.

When the dust core is prepared from the soft magnetic metal powder according to the present embodiment, the soft magnetic metal powder is put into a mold, and then a pressure is applied in the molding direction to perform the powder compaction and molding.

Although the magnetic core according to the present embodiment has been described above, the magnetic core of the present invention is not limited to the above embodiment.

A use of the magnetic core of the present invention is not particularly limited. Examples thereof include coil components (magnetic components) such as an inductor, a choke coil and a transformer.

### EXAMPLES

Hereinafter, the present invention will be described based on more detailed examples, but the present invention is not limited to these examples.

### Experimental Example 1

For samples No. 1 to 7, 3a, 3b and 3c, the soft magnetic metal powder having a composition shown in Table 1 was prepared.

The soft magnetic metal powder was prepared by the gas atomizing method using the metal powder manufacturing device 100 shown in FIG. 3. A melting temperature was 1500° C. and a type of a gas used was Ar. Table 1 shows an injection gas pressure for a molten metal. The inner diameter of the inner surface of the cylindrical body 32 in the metal powder manufacturing device 100 was 300 mm, θ1 was 20 degrees and θ2 was 0 degrees. W1/W2 was a value shown in Table 1. The obtained soft magnetic metal powder was classified by sieving so that an average particle size (D50) was 24 μm.

Then, the obtained soft magnetic metal powder was heat-treated. A heat treatment condition was 600° C. for 1 hour, and an atmosphere during the heat treatment was an Ar atmosphere.

The average particle size (D50) of the obtained soft magnetic metal powder was measured and confirmed to be all 24 μm. The average particle size was measured using a dry type particle size distribution measurement instrument (HELOS). In addition, it was confirmed that each soft magnetic metal powder had a structure formed of nanocrystals (a structure formed of the Fe-based nanocrystals).

As sample No. 8, a commercially available soft magnetic metal powder having a structure formed of nanocrystals (a structure formed of the Fe-based nanocrystals) was prepared. The average particle size (D50) was 24 μm.

Next, the soft magnetic metal powder was filled into a mold for samples No. 1 to 8. A shape of the mold was such that a shape of the finally obtained magnetic core would be toroidal.

Next, the soft magnetic metal powder was pressure-molded. A molding pressure was controlled so that the packing density of the magnetic core obtained at this time would be a value shown in Table 1. Specifically, the molding pressure was controlled within a range of 1 to 10 ton/cm².

A cross section cut parallel to the molding direction (a height direction) was observed for each experimental example. Specifically, at least 2000 particles having a particle size of 10 μm or more and less than 50 μm were observed in a plurality of measurement ranges by using the SEM. The magnification was 500 times. It was comfirmed that an average circle equivalent diameter obtained by measuring and averaging an circle equivalent diameter of each particle was substantially the same as the average particle size of the soft magnetic powder. It was also confirmed that a number ratio of the particles having the particle size of 10 μm or more and less than 50 μm to the particles contained in the magnetic core was 20% or more.

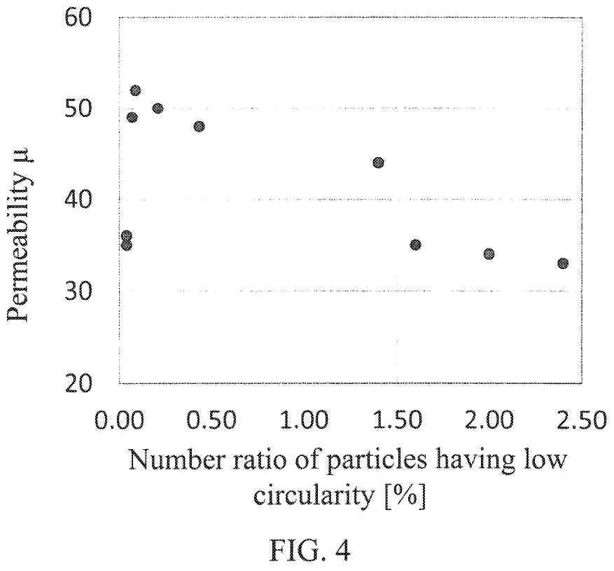

Then, a number ratio of particles having a low circularity, a packing density and a relative permeability in each magnetic core were measured. The number ratio of particles having a low circularity and the packing density in each magnetic core were calculated from SEM images. The relative permeability was measured using an impedance/GAIN-PHASE ANALYZER (manufactured by Yokogawa Hewlett-Packard Co., ltd., 4194A). In Experimental Example 1, a case where the relative permeability is higher than 40 is good, and a case where the relative permeability is 44 or more is even better. Table 1 shows the results. For samples 1 to 7, 3a, 3b and 3 c, FIG. 4 shows a graph with the number ratio of the particles having the low circularity on a horizontal axis and the relative permeability on a vertical axis.

TABLE 1

| | | | Gas | | Number ratio of particles | Packing | |
|---|---|---|---|---|---|---|---|
| Sample | Soft magnetic metal powder | | pressure | | having small circularity | density | Relative |
| No. | Microstructure | Composition (Atomic number ratio) | (MPa) | W1/W2 | (%) | (%) | permeability |
| 1 | Nanocrystal | Fe_{0.799}Nb_{0.070}B_{0.098}P_{0.031}S_{0.002} | 2 | 1/4 | 0.07 | 78 | 49 |
| 2 | Nanocrystal | Fe_{0.799}Nb_{0.070}B_{0.098}P_{0.031}S_{0.002} | 3 | | 0.09 | 78 | 52 |
| 3 | Nanocrystal | Fe_{0.799}Nb_{0.070}B_{0.098}P_{0.031}S_{0.002} | 10 | | 0.43 | 78 | 48 |
| 3a | Nanocrystal | Fe_{0.799}Nb_{0.070}B_{0.098}P_{0.031}S_{0.002} | 10 | 1/3 | 0.21 | 78 | 50 |
| 3b* | Nanocrystal | Fe_{0.799}Nb_{0.070}B_{0.098}P_{0.031}S_{0.002} | 10 | 1 | 0.04 | 78 | 36 |
| 3c* | Nanocrystal | Fe_{0.799}Nb_{0.070}B_{0.098}P_{0.031}S_{0.002} | 10 | 1/10 | 2.40 | 78 | 33 |
| 4 | Nanocrystal | Fe_{0.799}Nb_{0.070}B_{0.098}P_{0.031}S_{0.002} | 12 | 1/4 | 1.40 | 78 | 44 |
| 5* | Nanocrystal | Fe_{0.799}Nb_{0.070}B_{0.098}P_{0.031}S_{0.002} | 1 | | 0.04 | 78 | 35 |
| 6* | Nanocrystal | Fe_{0.799}Nb_{0.070}B_{0.098}P_{0.031}S_{0.002} | 15 | | 1.60 | 78 | 35 |
| 7* | Nanocrystal | Fe_{0.799}Nb_{0.070}B_{0.098}P_{0.031}S_{0.002} | 20 | | 2.00 | 78 | 34 |
| 8* | Nanocrystal | Fe_{0.734}Nb_{0.030}B_{0.091}Si_{0.135}Cu_{0.010} | — | | 0.04 | 78 | 40 |
| | (Commercially | | | | | | |
| | available) | | | | | | |

*refers to comparative example

From Table 1 and FIG. 4, a magnetic core in which the number ratio of the particles having the low circularity is 0.05% or more and 1.50% or less had a good relative permeability. In contrast, the magnetic core in which the number ratio of the particles having the low circularity is out of the range of 0.05% or more and 1.50% or less, the relative permeability was low even at the same packing density.

Sample No. 8 shows that the number ratio of the particles having the low circularity is too small even when the magnetic core is prepared using a commercially available soft magnetic metal powder. It is considered that this is because the commercially available soft magnetic metal powder is not prepared using the metal powder manufacturing device 100 shown in FIG. 3.

### Experimental Example 2

Experimental Example 2 was carried out in the same manner as samples No. 1 to 7 in Experimental Example 1 except that W1/W2=1/4 and the microstructure and composition of the soft magnetic metal powder were changed. The microstructure of the soft magnetic metal powder was controlled by changing the composition and the heat treatment condition. In addition, it was confirmed that the soft magnetic metal powder of samples No. 9 to 14 had a structure formed of crystals larger than the nanocrystals, and the soft magnetic metal powder of samples No. 15 to 17 had a amorphous structure. Table 2 shows the results. Since the relative permeability changes depending on the composition, a criterion for good relative permeability is different from that of Experimental Example 1.

TABLE 2

| | | | Number ratio of particles | Packing | |
|---|---|---|---|---|---|
| Sample | Soft magnetic metal powder | | having circularity of <0.5 | density | Relative |
| No. | Microstructure | Composition (Atomic number ratio) | (%) | (%) | permeability |
| 9 | Crystal | Fe | 1.22 | 78 | 19 |
| 10* | Crystal | Fe | 0.04 | 78 | 15 |
| 11* | Crystal | Fe | 2.43 | 78 | 16 |
| 12 | Crystal | Fe_{0.914}Si_{0.086} | 0.55 | 78 | 30 |
| 13* | Crystal | Fe_{0.914}Si_{0.086} | 0.04 | 78 | 24 |
| 14* | Crystal | Fe_{0.914}Si_{0.086} | 2.10 | 78 | 26 |
| 15 | Amorphous | Fe_{0.727}Si_{0.116}Cr_{0.022}B_{0.108}C_{0.027} | 0.12 | 78 | 42 |
| 16* | Amorphous | Fe_{0.727}Si_{0.116}Cr_{0.022}B_{0.108}C_{0.027} | 0.04 | 78 | 27 |
| 17* | Amorphous | Fe_{0.727}Si_{0.116}Cr_{0.022}B_{0.108}C_{0.027} | 1.77 | 78 | 25 |
| 18 | Amorphous | Co_{0.71}Fe_{0.04}Si_{0.15}B_{0.10} | 0.15 | 78 | 45 |
| 19* | Amorphous | Co_{0.71}Fe_{0.04}Si_{0.15}B_{0.10} | 0.04 | 78 | 31 |
| 20* | Amorphous | Co_{0.71}Fe_{0.04}Si_{0.15}B_{0.10} | 1.68 | 78 | 30 |

*refers to comparative example

From Table 2, when the microstructure and composition of the soft magnetic metal powder were the same and the packing density was the same, the relative permeability of the magnetic core in which the number ratio of the particles having the low circularity is 0.05% or more and 1.50% or less was relatively high.

### Experimental Example 3

Experimental Example 3 was carried out in the same manner as sample No. 3 in Experimental Example 1 except that W1/W2=1/4 and the composition of the soft magnetic metal powder was changed. The microstructure of the soft magnetic metal powder was controlled by changing the heat treatment condition. The number ratio of the particles having the small circularity was controlled by changing the gas pressure during gas atomization. Table 3 shows the results.

TABLE 3

| | Fe_{(1-(a+b+c+d+e+f))}MₐB_{b}P_{c}Si_{d}CₑS_{f} | | | | | | Average | Number ratio of | Packing | |
|---|---|---|---|---|---|---|---|---|---|---|
| Sample | M(Nb) | B | P | Si | C | S | particle size | particles having | density | Relative |
| No. | a | b | c | d | e | f | D50 (μm) | small circularity (%) | (%) | permeability |
| 3 | 0.070 | 0.098 | 0.031 | 0.000 | 0.000 | 0.002 | 24 | 0.43 | 78 | 48 |
| 21 | 0.000 | 0.098 | 0.031 | 0.000 | 0.000 | 0.002 | 24 | 0.43 | 78 | 41 |
| 22 | 0.140 | 0.098 | 0.031 | 0.000 | 0.000 | 0.002 | 24 | 0.43 | 78 | 41 |
| 23 | 0.150 | 0.098 | 0.031 | 0.000 | 0.000 | 0.002 | 24 | 0.43 | 78 | 38 |
| 24 | 0.070 | 0.000 | 0.031 | 0.000 | 0.000 | 0.002 | 24 | 0.43 | 78 | 38 |
| 24a | 0.070 | 0.010 | 0.031 | 0.000 | 0.000 | 0.002 | 24 | 0.43 | 78 | 41 |
| 25 | 0.070 | 0.200 | 0.031 | 0.000 | 0.000 | 0.002 | 24 | 0.43 | 78 | 41 |
| 26 | 0.070 | 0.220 | 0.031 | 0.000 | 0.000 | 0.002 | 24 | 0.43 | 78 | 39 |
| 27 | 0.070 | 0.098 | 0.000 | 0.000 | 0.000 | 0.002 | 24 | 0.43 | 78 | 41 |
| 28 | 0.070 | 0.098 | 0.200 | 0.000 | 0.000 | 0.002 | 24 | 0.43 | 78 | 42 |
| 29 | 0.070 | 0.098 | 0.220 | 0.000 | 0.000 | 0.002 | 24 | 0.43 | 78 | 39 |
| 30 | 0.070 | 0.098 | 0.031 | 0.140 | 0.000 | 0.002 | 24 | 0.43 | 78 | 42 |
| 31 | 0.070 | 0.098 | 0.031 | 0.150 | 0.000 | 0.002 | 24 | 0.43 | 78 | 39 |
| 32 | 0.070 | 0.098 | 0.031 | 0.000 | 0.200 | 0.002 | 24 | 0.43 | 78 | 42 |
| 33 | 0.070 | 0.098 | 0.031 | 0.000 | 0.220 | 0.002 | 24 | 0.43 | 78 | 39 |
| 34 | 0.070 | 0.098 | 0.031 | 0.000 | 0.000 | 0.000 | 24 | 0.43 | 78 | 45 |
| 35 | 0.070 | 0.098 | 0.031 | 0.000 | 0.000 | 0.020 | 24 | 0.43 | 78 | 41 |
| 36 | 0.070 | 0.098 | 0.031 | 0.000 | 0.000 | 0.030 | 24 | 0.43 | 78 | 39 |

From Table 3, the particles have a main component formed of a composition formula (Fe_{(1-(α+β))}X1_{α}X2_{β})_{(1-(a+b+c+d+e+f))}MₐB_{b}P_{c}Si_{d}CₑS_{f},
in which X1 is one or more selected from the group consisting of Co and Ni,
X2 is one or more selected from the group consisting of Al, Mn, Ag, Zn, Sn, As, Sb, Cu, Cr, Bi, N, O and rare earth elements,
M is one or more selected from the group consisting of Nb, Hf, Zr, Ta, Mo, W, Ti and V, and when the following conditions are satisfied:

$$0. \leq a \leq 0.140$$

$$0.01 \leq b \leq 0 \text{.20}$$

$$0. \leq c \leq 0.20$$

$$0 \leq d \leq 0.14$$

$$0 \leq e \leq 0.2$$

$$0 \leq f \leq 0.02$$

$$0.698 \leq 1 - ( a + b + c + d + e + f ) \leq 0. 93$$

$$α \geq 0$$

$$β \geq 0$$

$$0 \leq α + β \leq 0.50$$

(samples No. 3, 21, 22, 24a, 25, 27, 28, 30, 32, 34, 35), the relative permeability was improved as compared with a case where any of a to f was out of the above range (samples No. 23, 24, 26, 29, 31, 33, 36). At least samples No. 3, 21, 22, 24a, 25, 27, 28, 30, 32, 34, 35 were confirmed to have a structure formed of the Fe-based nanocrystals.

Regarding the case where any of a to f was out of the above range, when the number ratio of the particles having the small circularity is out of the range of 0.05% or more and 1.50% or less, it was confirmed that the relative permeability was further reduced as compared with a case where the number ratio of the particles having the same composition and the small circularity was within the range of 0.05% or more and 1.50% or less (as described in Table 3).

DESCRIPTION OT THE REFERENCE NUMERAL

| | |
|---|---|
| 20 | molten metal supply unit |
| 21 | molten metal |
| 22 | container |
| 24 | heating coil |
| 26 | gas injection nozzle |
| 30 | cooling unit |
| 32 | cylindrical body |
| 33 | inner surface (inner circumferential surface) |
| 34 | discharge portion |
| 36 | coolant introduction portion (coolant lead-out portion) |
| 37 | nozzle |
| 38 | frame body |
| 40 | partition portion |
| 42 | passage portion |
| 44 | outer portion (outer space portion) |
| 46 | inner portion (inner space portion) |
| 50 | coolant flow |
| 52 | coolant discharge portion |
| 100 | metal powder manufacturing device |

1. A magnetic core comprising soft magnetic metal powder particles,
wherein a number ratio of soft magnetic metal powder particles having a circularity of less than 0.50 to a total number of soft magnetic metal powder particles having a particle size of 10 μm or more and less than 50 μm is 0.05% or more and 1.50% or less in a cross section of the magnetic core, the soft magnetic metal powder particles comprise one or more elements selected from the group consisting of Fe, Co and Ni, and a total content of Fe, Co and Ni in the soft magnetic powder particles is 59.9 at % or more.

2. The magnetic core according to claim 1,
wherein the soft magnetic metal powder particles are amorphous.

3. The magnetic core according to claim 1,
wherein the soft magnetic metal powder particles contain nanocrystals.

4. A coil component comprising:
the magnetic core according to claim 1.

5. The magnetic core according to claim 1,
wherein the number ratio of soft magnetic metal powder particles having a circularity of less than 0.50 to the total number of soft magnetic metal powder particles having a particle size of 10 μm or more and less than 50 μm is 0.07% or more and 1.40% or less.

6. The magnetic core according to claim 3,
wherein the nanocrystals has an average crystal grain size of 0.1 nm or more and 100 nm or less.

7. The magnetic core according to claim 1,
wherein the soft magnetic metal powder particles have a structure formed of Fe-based nanocrystals.

8. The magnetic core according to claim 7,
wherein the Fe-based nanocrystals are crystals have an average crystal grain size on a nano-order and a Fe crystal structure that is a bcc.

9. The magnetic core according to claim 7,
wherein the Fe-based nanocrystals have an average crystal grain size of 5 to 30 nm.

10. The magnetic core according to claim 7,
wherein the soft magnetic metal powder particles consisting of a composition formula (Fe_{(1-(α+β))}X1_{α}X2_{β})_{(1-(a+b+c+d+e+f)}MₐB_{b}P_{c}Si_{d}CₑS_{f}, in which
X1 is one or more selected from the group consisting of Co and Ni,
X2 is one or more selected from the group consisting of Al, Mn, Ag, Zn, Sn, As, Sb, Cu, Cr, Bi, N, O and rare earth elements,
M is one or more selected from the group consisting of Nb, Hf, Zr, Ta, Mo, W, Ti and V, and the following conditions are satisfied:
$$0. \leq a \leq 0.1 \; 40$$
$$0. \leq b \leq 0.2 \; 00$$
$$0. \leq c \leq 0.2 \; 00$$
$$0. \leq d \leq 0.1 \; 40$$
$$0. \leq e \leq 0.2 \; 00$$
$$0. \leq f \leq 0.0 \; 20$$
$$0.599 \leq 1 - ( a + b + c + d + e + f ) \leq 0.930$$
$$α \geq 0$$
$$β \geq 0$$
$$0 \leq α + β \leq 0.50 .$$

11. The magnetic core according to claim 10,
wherein 0.001≤b≤0.200 is satisfied.

12. The magnetic core according to claim 10,
wherein M is Nb.

13. The magnetic core according to claim 10,
wherein 0.599≤1−(a+b+c+d+e+f)≤0.897 is satisfied.

14. The magnetic core according to claim 10,
wherein d=0 is satisfied.

15. The magnetic core according to claim 10,
wherein e=0 is satisfied.

16. The magnetic core according to claim 10,
wherein β=0 is satisfied.
